(19) United States
(12) Patent Application Publication
(10) Pub. No.: US 2016/0039148 A1
(43) Pub. Date: Feb. 11, 2016

(54) 3-D PRINTER HAVING MOTION SENSORS

(71) Applicant: DELAWARE CAPITAL FORMATION, INC., Wilmington, DE (US)

(72) Inventor: Kenneth D. Marino, Long Beach, CA (US)

(21) Appl. No.: 14/452,345

(22) Filed: Aug. 5, 2014

(51) Int. Cl. B29C 67/00

(52) U.S. Cl. CPC B29C 67/0088; B33Y 30/00

(57) ABSTRACT

A three-dimensional printer including a print head for extruding a print material and a build platform for receipt the print material, the print head and the build platform each having a motion sensor for generating a position signal to a controller which compares the actual position of the print head and the build platform with a desired position of the print head and the build platform for generating an error signal to x-y axis and z-y axis translators to minimize relative motion between the print head and the build platform and unwanted positional error in an x-y printing plane.

### FIELD OF THE INVENTION

This invention is directed to a three-dimensional printer, and more specifically a three-dimensional printer having motion sensors attached to or monitoring both the print head and the build platform in order to provide a closed feedback loop to a motion controller.

### BACKGROUND OF THE INVENTION

Through increased use of computer aided design (CAD) solid modeling systems have developed which translates CAD output data into a structural component. Forming objects automatically in three-dimensions is useful in testing for input CAD errors, part functionality, assessing aesthetics, mold formation by subtractive wax, and small production runs. While some of these applications are somewhat insensitive to short and long range dimensional errors, such as assessing of aesthetics, other applications are moderately sensitive to error, such as testing part functionality. Still other applications, such as mold manufacturing, are extremely sensitive to dimensional errors.

Automated three-dimensional part printing techniques that are currently available exhibit generally poor long range dimensional tolerance. In addition three-dimensional printing, also known as additive manufacturing, currently suffers from poor surface finish on the printed part that requires post processing such as sanding to improve the finish. Part of the reason that the surface finish is rough is due to the inherent processing needs, which induce unwanted motion into the print head and the build platform. Consequently a need exists to improve motional compensation for one or both of the print head or the build platform to improve the print quality.

### SUMMARY OF THE INVENTION

The present invention provides a three-dimensional printer incorporating motion sensors which monitor or are attached to both a print head and a build platform in order to provide a closed feedback loop to a motion controller such that the relative motion between the build platform and the print head is minimized and unwanted positional error is minimized in the x-y printing plane. The motion sensors can be accelerometers, optical motion sensors or piezoelectric sensors. Providing motional compensation and adjustments to both the print head and the build platform improves print quality.

The 3-D printer includes a nozzle for extruding a material, apparatus for controllably positioning the nozzle in accordance with the specification; and apparatus for generating a feedback signal that is indicative of at least one characteristic of a most recently extruded portion of the material. In one embodiment the feedback generating apparatus includes a visual or infrared emission imaging system. In another embodiment the feedback generating apparatus includes a proximity detecting apparatus such as a capacitive sensor, tactile sensor, or pneumatic sensor. The positioning apparatus is responsive to a nozzle movement list stored within a controller for translating the nozzle horizontally within an x-y plane and further comprising an object supporting stage that is translated vertically along a z-axis. The positioning apparatus is also operable for translating the nozzle in the z-axis.

The material may be comprised of, but is not limited to adhesives, waxes, thermoplastic polymers, thermoset polymers, resins, metallic alloys, glasses, epoxy resins, silicone adhesives, and combinations thereof. The material may also include combinations containing dissimilar materials added to impart a desired electrical or structural characteristic to the material.

### BRIEF DESCRIPTION OF THE DRAWINGS

FIG. 1 is a block diagram of a 3-D printer of the present invention; and

FIG. 2 is a block diagram of motion detection and feedback for z-axis relative motion between the print head and the build platform.

### DETAILED DESCRIPTION

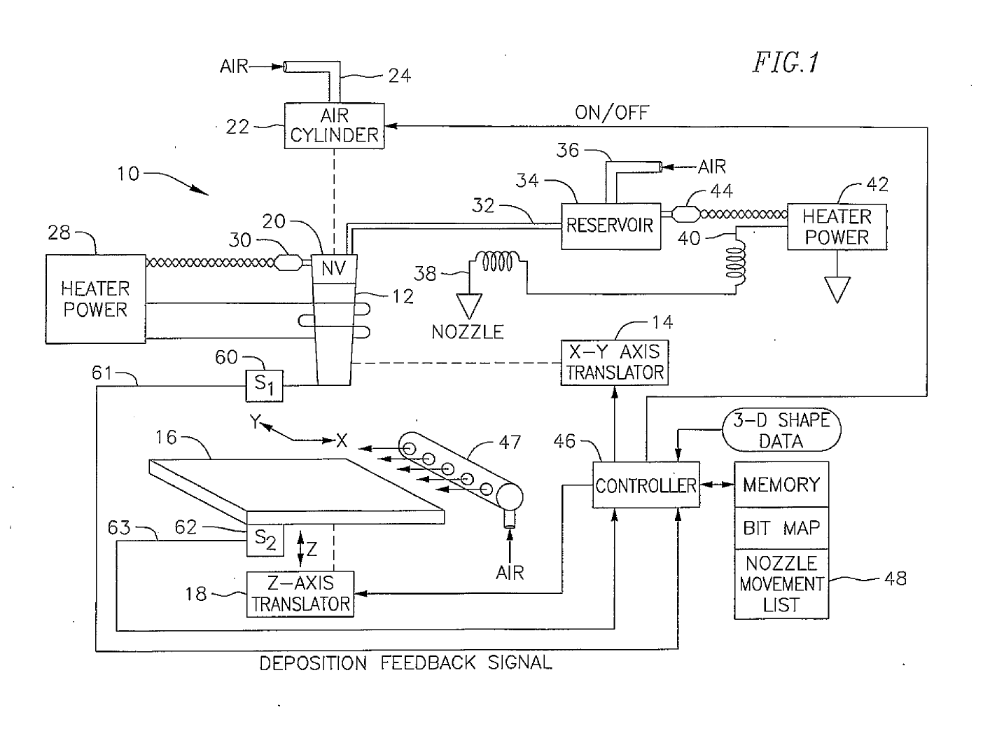

Referring to FIG. 1, a three-dimensional printer 10 is illustrated. Printer 10 includes a nozzle 12, also referred to as the print head, that is coupled to an x-y gantry-type translator 14. Through the use of the translator 14 the nozzle 12 is controllably translated within a horizontally disposed x-y plane. Nozzle 12 is disposed over a table 16, also referred to as the build platform, that is coupled to a z-axis translator 18. During operation, the nozzle 12 is controllably translated in the x-y plane in order to extrude a layer of material. After extruding a layer of material the z-axis translator is activated to lower the table 16 by an increment equal to the thickness of the extruded material. The nozzle 12 is then again translated in the x-y plane to deposit a next layer directly upon the immediately lower layer. The nozzle 12 includes a needle valve 20 that is coupled to a bidirectional air cylinder 22. Air cylinder 22 is provided, through a conduit 24, with a source of compressed air at a pressure suitable for activating the needle valve 20, thereby controlling the on/off flow of material through the nozzle 12.

Coupled to nozzle 12 is a nozzle heater 26 which is connected to a source of heater power 28. The heat sensing means, such as a thermocouple 30, contacts the nozzle 12 for maintaining the desired temperature, which is a function of the material being extruded. A conduit 32 is connected to the nozzle 12 and provides for a flow of melted material to be provided to the nozzle 12. This material is held in a heated reservoir 34 that is coupled, via a conduit 36, to a source of compressed air operating at a desired pressure. Conduit 32 has an associated heater 38 and reservoir 34 as an associated heater 40 both of which are connected to a source of heater power 42. A heat sensing means, such as a thermocouple 44, as provided for maintaining the reservoir within a predetermined range of temperatures. The range of temperatures is a function of the melting point of the selected material.

Coupled to the x-y axis translator 14, the z-axis translator 18, and to the needle valve air cylinder 22 is a controller 46. Controller 46 may be embodied in a personal computer data processing system. Connection to the translators 14 and 18 may be made by any suitable means such as a parallel communications port or a serial communications port. Controller 46 has an input for receiving three-dimensional shaped data from a CAD system and has a memory 48 for storing data representative of the structure being extruded by the nozzle.

For certain extrusion materials the various heaters shown may be eliminated altogether. In addition, for those materials that are heated during or after extrusion, a local source of air or some other gas has been found to speed cooling of the material. By example, a duct 47 having a plurality of openings is coupled to a source of air and is disposed such that it provides substantially uniformed flow of cooling air to the plane where extrusion is occurring.

The printer 10 may include a deposition feedback system comprised of a feedback sensor 60 which operates near the tip of nozzle 12 and which provides a feedback signal to the controller 46. This feedback signal is indicative of a characteristic of the extruded bead. More specifically, the feedback sensor 60 detects a position or other characteristic of a most recently extruded portion of the material. By example, the sensor 60 may detect the position of the extruded bead relative to a positional reference system, the bead position being monitored by the controller 46 so as to make adjustments, if required to the nozzle 12 position during extrusion. This technique advantageously permits a finer control of the geometry of the extruded structure and results in a structure that more closely approaches that defined by the three-dimensional shape data. The feedback signal, depending upon the particular type of sensor 60 that is employed, may also provide other information, such as temperature of the extruded bead or a dielectric characteristic thereof.

The feedback provided by the sensor 60 is important and that a number of different mechanisms may operate that result in the extruded material having dimensions other than those intended. For example, when the extruded bead is applied around a convex or concave contour the bead, while still hot enough to be pliable, tends to distort to minimize its length. Also, and depending on the distance from the nozzle to the underlying material, the extruded bead may change its deposited cross-section as a function of this distance. Also, it has been found that back pressure from already deposited material that is near the nozzle may reduce the flow rate out of the nozzle. Also, changes in temperature or composition of the material to be extruded may change the rate at which the material flows out of the nozzle and, as a result, the rate at which the material solidifies to its final dimension.

The feedback sensor 60 may be embodied by a number of different devices that are either fixed to the frame of the system or which are translated with the nozzle 12. In general, the feedback sensor 60 may be embodied within imaging devices or within proximity sensing devices. In either case, the sensors function to provide information regarding the most recently extruded material. More specifically, suitable sensors include, but are not limited to, visible imaging devices, infrared emission imaging devices, capacitive detection devices, tactile detection devices, and pneumatic detection devices.

In addition to sensor 60 which may be attached to nozzle 20, a second sensor 62 is attached to the table 16 for sending a signal to the controller 46. Both sensors 60 and 62 can be high bandwidth motion sensors such as accelerometers, optical motion sensors, piezoelectric sensors which are physically attached or can monitor both the print head and the build platform to provide a closed loop feedback signals 61, 63 to the controller 46 such that the relative motion between the build platform and the print head is minimized thereby eliminating unwanted positional error in the x-y printing plane.

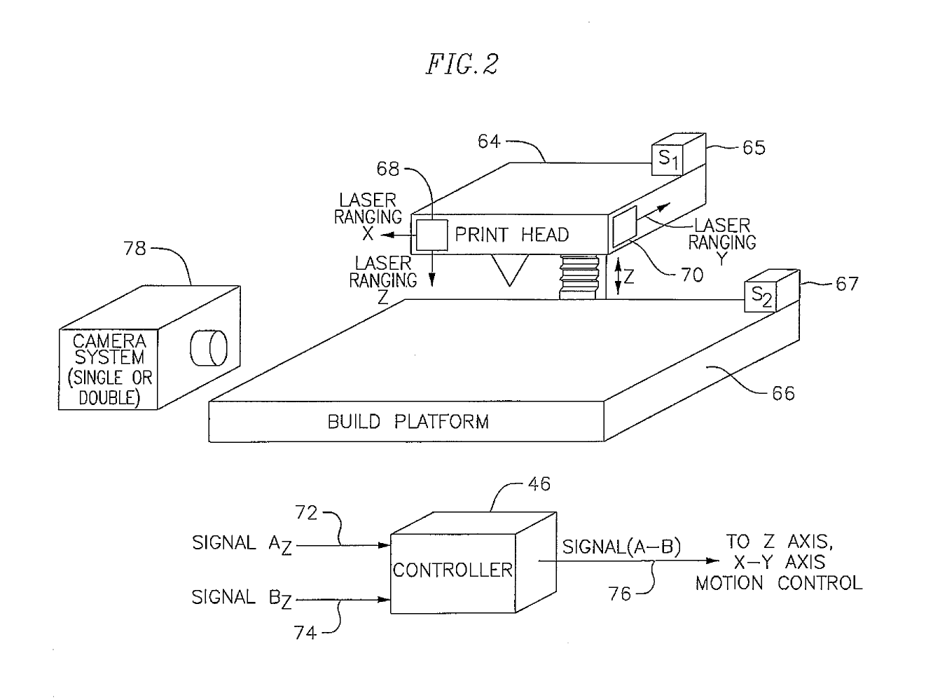

As also shown in FIG. 2, the print head 64 includes sensor S1 65 and the build platform 66 includes sensor S2 67. The print head can include lasers 68 and 70 which range in the x-y and z directions. Sensor S1 sends signal A_{z} 72 to the controller 46 and sensor S2 sends signal B_{z} 74 to the controller which would then generate an error signal 76 to the x-y axis translator 14 and the z-axis translator 18 to provide motional compensation and adjustments to both the print head and the build platform to improve the print quality. The x-y axis translator and the z-axis translator can be, for example stepper motors. To determine the deposition position of the material being extruded from the nozzle, an optical system including a camera system 78 provides an optical deposition feedback signal to the controller.

Although the present invention has been described and illustrated with respect to an embodiment thereof, it is to be understood that changes and modifications can be made therein which are within the full intended scope of the invention as hereinafter claimed, for example, the nozzle can be translated in the z-axis and the build platform can be translated in the x-y axis.

What is claimed is:

1. A system for printing a three-dimensional object in accordance with a specification of the object comprising:
a print head for extruding a print material;
a build platform for receipt of the print materials;
an x-y axis translator for moving at least one of the print head or the built platform in an x-y plane;
a z-axis translator for moving at least one of the print head or the build platform in a z-axis plane;
a print head sensor for monitoring the position of the print head;
a build platform sensor for monitoring the position of the build platform; and
a controller for receipt of a signal from the print head sensor and the build platform sensor which generates an error signal to the x-y axis translator and the z-axis translator to minimize unwanted positional error in the x-y plane.

2. The system of claim 1 wherein the x-y axis translator is a stepper motor.

3. The system of claim 1 wherein the z-axis translator is a stepper motor.

4. The system of claim 1 wherein the print head sensor is a motion sensor.

5. The system of claim 4 wherein the motion sensor is one of an accelerometer, optical motion sensor or piezoelectric sensor.

6. The system of claim 1 wherein the build section sensor is a motion sensor.

7. The system of claim 6 wherein the motion sensor is one of an accelerometer, optical motion sensor or piezoelectric sensor.

8. A three-dimensional printer comprising:
a nozzle for dispensing print material;
a table for receipt of the print material;
means for sensing an actual x-y axis and z-axis position of the nozzle and the table;
means for comparing the actual x-y axis and z-axis position of the nozzle and the table with a desired x-axis and z-axis position of the nozzle and the table and calculating an error signal if the actual x-y axis and z-axis position and the desired x-y axis and z-axis position are not the same; and
an x-y axis controller and a z-axis controller which moves at least one of the nozzle on the table in response to the error signal.

9. The printer of claim 8 wherein the means for sensing is a nozzle motion sensor and a table motion sensor.

10. The printer of claim 9 wherein the nozzle motion sensor and the table motion sensor are one of an accelerometer, optical or motion sensor or piezoelectric sensor.

11. The printer of claim 8 wherein the means for comparing is a controller adapted to provide a closed loop feedback signal to the x-y axis translator and the z-axis translator to minimize relative motion between the nozzle and the table and unwanted positional error in an x-y printing plane.

12. The printer of claim 8 wherein the x-y axis translator and the z-axis translator are stepper motors.

13. A three-dimensional printer comprising:
a print head with a motion sensor and a build platform with a motion sensor for monitoring the position of the print head and the build platform;
x-y axis and z-axis translators for the print head and the build platform; and
a closed loop feedback controller adapted to generate signals to the x-y axis translator and the z-y axis translator in response to motion sensor signals to minimize the relative motion between the print head and the build platform and unwanted positional error in an x-y printing plane.

14. The printer of claim 13 wherein the motion sensor is one of an accelerometer, optical motion sensor or piezoelectric sensor.

15. The printer of claim 13 wherein the x-y axis and z-y axis translator are stepper motors.

16. The printer of claim 13 wherein the print head includes a nozzle.

17. The printer of claim 13 wherein the build platform includes a table.
